(19) United States
(12) Patent Application Publication
(10) Pub. No.: US 2010/0239120 A1
(43) Pub. Date: Sep. 23, 2010

(54) IMAGE OBJECT-LOCATION DETECTION METHOD

(76) Inventor: Wei Hsu, Taoyuan County (TW)

Correspondence Address: NORTH AMERICA INTELLECTUAL PROPERTY CORPORATION, P.O. BOX 506, MERRIFIELD, VA, 22116, US

(21) Appl. No.: 11/463,010

(22) Filed: Aug. 8, 2006

(30) Foreign Application Priority Data
May 19, 2006 (TW) 095117798

(51) Int. Cl. G06K 9/00

(52) U.S. Cl. 382/103

(57) ABSTRACT

An image object-location detection method includes dividing a target image into a plurality of image blocks, calculating a plurality of sharpness values respectively corresponding to the plurality of image blocks, and analyzing the plurality of sharpness values to accordingly select image blocks corresponding to object-locations in the target image from the plurality of image blocks.

### BACKGROUND OF THE INVENTION

1. Field of the Invention

The invention relates to image object-location detection, and more particularly, to an image object-location detection method applying a sharpness value calculation.

2. Description of the Prior Art

Image object-location detection, which detects object-locations in a target image, is a technique having extensive applications. For example, this technique can be used in surveillance systems for tracing objects, locking objects, or enlarging characteristics. The technique can also be used in digital cameras or digital video cameras for assisting auto focus, auto exposure, or auto white balance. Additionally, image object-location detection allows identification/detection systems to recognize car license plates, human faces, or other objects. Image based missiles can use this technique to assist target tracing. Researchers can use image object-location detection to simplify image-analyzing processes.

Generally speaking, image object-location detection modules must provide accurate object-locations to backend applications in order to allow the backend applications to perform correct operations. Incorrect object-locations provided by the image object-location detection modules might lead to erroneous operations of the backend applications.

FIG. 1 illustrates how auto focus is achieved through image object-location detection. For a target image 100, the prior art method compares the average brightness of five fixed detection blocks in the target image 100. According to the brightness comparing result, the method selects one from the five fixed detection blocks as an object-location block of the target image 100. The object-location block is then utilized as a target of focusing. As shown in FIG. 1, the five detection blocks include a center detection block 110, a left detection block 120, a right detection block 130, an up detection block 140, and a down detection block 150. The locations, sizes, and shapes of the five detection blocks are fixed and cannot be adjusted adaptively. Therefore, only objects that lie within the five detection blocks can be detected as object-locations. If object-locations of the target image 100 do not lie in any of the five detection blocks, erroneous detection result will be generated. If the target image 100 includes more than one object-locations lying in different detection blocks, only one of them will be chosen as the object-location block. In other words, the detection result cannot reveal the fact that the target image 100 includes more than one object-location, which lie in different detection blocks. For example, if one object-location is in the left detection block 120 while another object-location is in the right detection block 130, only one of these two detection blocks can be chosen as the object-location block. The detection result is therefore not fully correct. Additionally, since the locations, sizes, and shapes of the five detection blocks are fixed, the method cannot provide further information on the shape of the detected object if the object has an irregular shape.

### SUMMARY OF THE INVENTION

One of the objectives of the present invention is to provide an image object-location detection method that detects object-locations in a more flexible manner.

An image object-location detection method is disclosed. The method comprises dividing a target image into a plurality of image blocks, calculating a plurality of sharpness values respectively corresponding to the plurality of image blocks, and analyzing the plurality of sharpness values to accordingly select image blocks corresponding to object-locations in the target image from the plurality of image blocks.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates how auto focus is achieved through image object-location detection.

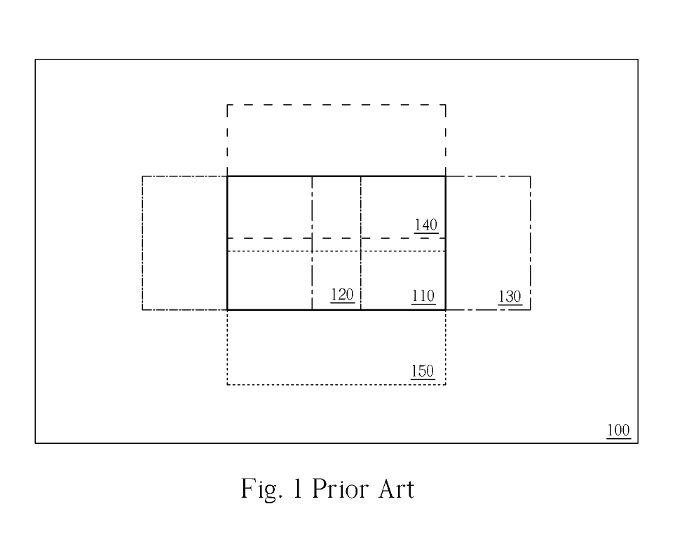

FIG. 2 shows an exemplary flowchart of the proposed image object-location detection method.

### DETAILED DESCRIPTION

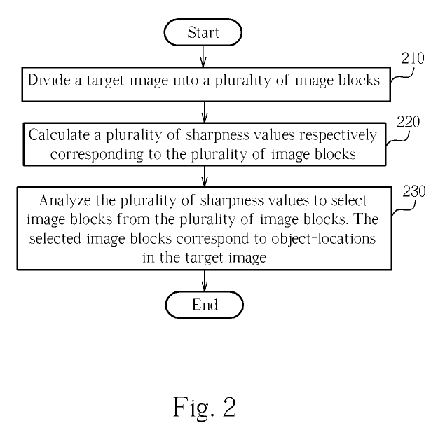

In short, the present invention applies the idea of sharpness value calculation in the technique of image object-location detection. FIG. 2 shows an exemplary flowchart of the proposed image object-location detection method. The flowchart comprises the following steps.

Step 210: Divide a target image into a plurality of image blocks {IB_{x,y}|1<=x<=M, 1<=y<=N}. In this example, the target image is divided into M equal parts along a horizontal axis; and each of the M equal parts is further divided into N equal image blocks. Therefore, the total amount of the plurality of image blocks is M*N. For instance, M is equal to 12 and N is equal to 8.

Step 220: Calculate a plurality of sharpness values {SV(x, y)|1<=x<=M, 1<=y<=N} corresponding to the plurality of image blocks {IB_{x,y}|1<=x<=M, 1<=y<=N}. For example, a sharpness function can be used in this step to calculate the plurality of sharpness values {SV(x, y)|1<=x<=M, 1<=y<=N}. Generally speaking, when an image block includes more high frequency components, the calculated sharpness value of the image block is also larger.

Step 230: Analyze the plurality of sharpness values {SV(x, y)|1<=x<=M, 1<=y<=N} to image blocks from the plurality of image blocks {IB_{x,y}|1<=x<=M, 1<=y<=N} accordingly. The selected image blocks correspond to object-locations in the target image.

For instance, experimental results prove that object-locations tend to lie in image blocks having higher sharpness values. Therefore, in step 230 the plurality of sharpness values {SV(x, y)|1<=x<=M, 1<=y<=N} are sorted according to their magnitude. A set of image blocks are then selected from the plurality of image blocks so that the sorted order of each of the set of image blocks lies within a predetermined percentage range of the sorted orders of the plurality of sharpness values {SV(x, y)|1<=x<=M, 1<=y<=N}. In one experiment, after more than two thousand images were analyzed, it was found that the top 40% serves as a relatively good example of the predetermined percentage range. In addition, any sub-range of the top 60%, ex. top 5%, top 10%, . . . , or top 60%, can also be used as the predetermined percentage range.

If the target image is divided into 12*8=96 image blocks in step 210, 96 sharpness values respectively corresponding to the 96 image blocks are calculated in step 220. In step 230, the 96 sharpness values are sorted according to their magnitude, and image blocks with sorted orders lying within a predetermined percentage range of the sorted orders of the 96 sharpness values are selected. Since the selected image blocks may lie anywhere in the target, the method allows information concerning object shape to be provided in more detail. Additionally, the chosen image blocks may correspond to two, three, or more objects, which are not adjacent to each other. Therefore the operation result of the method can provide more information concerning objection-location and objection-shape.

Alternatively, in step 230 the plurality of sharpness values are sorted according to their magnitudes. Assuming that from high to low, the plurality of sorted sharpness value are SV_1, SV_2, SV_3, . . . , and SV_M*N, then a summation value SV_SUM of the plurality of sharpness values is calculated, where SV_SUM=SV_1+SV_2+SV_3+ . . . +SV_M*N. Next, a set of image blocks is selected from the plurality of image blocks so that an accumulated sharpness value of the set of image blocks reaches a predetermined percentage of the summation value SV_SUM. The predetermined percentage may lie between 0% and 60%, and 40% serves as a relatively good example of the predetermined percentage. Image blocks included in the set of image blocks are utilized as the selected image blocks corresponding to object-locations in the target image. For instance, in step 230 a value n satisfying the following equation is determined first. Then the n image blocks corresponding to the top n sharpness values SV_1, SV_2, SV_3, . . . , and SV_n are selected as the set of image blocks.

$${\sum }_{i = 1}^{n - 1} SV\_i < 0.4 \times SV\_SUM \leq {\sum }_{i = 1}^{n} SV\_i$$

Furthermore, most of the time, main objects are located at or near the center of the target image, therefore in step 230 each of the plurality of sharpness values SV(x, y) can be multiplied by a corresponding weighting factor WF(x, y) to obtain a weighted sharpness value WSV(x, y). Then a plurality of weighted sharpness values {WSV(x, y)|1<=x<=M, 1<=y<=N} are analyzed to select image blocks corresponding to object-locations in the target image.

For example, in step 230 the M*N weighted sharpness values are sorted according to their magnitude. Then, a set of image blocks are selected from the plurality of image blocks so that the sorted order of each of the set of image blocks lies within a predetermined percentage range of the sorted orders of the plurality of weighted sharpness values {WSV(x, y)|1<=x<=M, 1<=y<=N}. Herein 40% serves as a relatively good example of the predetermined percentage range. In addition, any sub-range of the top 60%, ex. top 5%, top 10%, . . . , or top 60%, can also be used as the predetermined percentage range.

Beside, in step 230 after the plurality of weighted sharpness values {WSV(x, y)|1<=x<=M, 1<=y<=N} are sorted according to their magnitude, a summation value WSV_SUM of the plurality of weighted sharpness values is calculated. Next, a set of image blocks is selected from the plurality of image blocks so that an accumulated weighted sharpness value of the set of image blocks reaches a predetermined percentage of the summation value WSV_SUM. The predetermined percentage may lie between 0% and 60%, where 40% serves as a relatively good example of the predetermined percentage. Image blocks included in the set of image blocks are utilized as the selected image blocks corresponding to object-locations in the target image.

The following equation illustrates an example of the aforementioned weighting factor WF(x, y)

WF(x,y)=0.6, 0<x<=4 and 0<y<=3

0.8, 4<x<=8 and 0<y<=3

0.6, 8<x<=12 and 0<y<=3

0.8, 0<x<=4 and 3<y<=5

1.0, 4<x<=8 and 3<y<=5

0.8, 8<x<=12 and 3<y<=5

0.6, 0<x<=4 and 5<y<=8

0.8, 4<x<=8 and 5<y<=8

0.6, 8<x<=12 and 5<y<=8

After object-locations of the target image are determined, the information can be passed to a backend application. For example, if the backend application is an auto focus application, in a search loop of the auto focus application the determined object-locations can be used as focusing targets. Setting values that provide the best focus result on the focusing targets are then chosen as optimal setting values.

Testing the proposed method on platforms of complementary metal oxide semiconductor (CMOS) image sensors and charge-coupled device (CCD) image sensors, positive test results are generated. In one experiment, after 2000 test images are analyzed, object-locations of most of the test images, approximately 98.06%, can be accurately found. Furthermore, experimental results show that even if the target image is blurred, with low brightness, with a complex background, or with object-locations that do not lie at the center, object-locations can still be correctly found. Since the proposed method requires only passive image analyzing, no additional hardware is needed. Therefore, hardware cost will not be increased. Furthermore, the proposed method can be designed as technical modules and be embedded in different kinds of platforms to provide service to back end applications.

Those skilled in the art will readily observe that numerous modifications and alterations of the device and method may be made while retaining the teachings of the invention. Accordingly, the above disclosure should be construed as limited only by the metes and bounds of the appended claims.

1. An image object-location detection method, the method comprising the following steps:
dividing a target image into a plurality of image blocks;
calculating a plurality of sharpness values respectively corresponding to the plurality of image blocks; and
analyzing the plurality of sharpness values to accordingly select image blocks corresponding to object-locations in the target image from the plurality of image blocks;
wherein the step of analyzing the plurality of sharpness values comprises:
sorting the plurality of sharpness values according to their magnitude; and
selecting a set of image blocks from the plurality of image blocks so that the sorted order of each of the set of image blocks lies within a predetermined percentage range of the sorted orders of the plurality of sharpness values.

2-5. (canceled)

6. The method of claim 1, wherein the predetermined percentage range is a sub-range of a top 60% range.

7. The method of claim 1, wherein the predetermined percentage range is a top 40% range.

8-14. (canceled)
